(19) United States
(12) Patent Application Publication
(10) Pub. No.: US 2006/0001011 A1
(43) Pub. Date: Jan. 5, 2006

(54) Surface conditioner for powder coating systems

(76) Inventors: Neil Richard Wilson, Lake Orion, MI (US); Toby P. Couture, Roseville, MI (US)

Correspondence Address: WOODCOCK WASHBURN LLP, ONE LIBERTY PLACE, 46TH FLOOR, PHILADELPHIA, PA, 19103, US

(21) Appl. No.: 11/172,080

(22) Filed: Jun. 30, 2005

Related U.S. Application Data
(60) Provisional application No. 60/585,029, filed on Jul. 2, 2004.

(51) Int. Cl. B05D 3/00; C04B 28/36; H01B 1/12

(52) U.S. Cl. 252/500; 427/180; 427/299; 106/287.23

(57) ABSTRACT

The present invention relates to methods for conditioning a surface before application of powder coating, methods for improving powder coating transfer to a surface, methods for reducing defects on powder painted surfaces, methods for providing homogenous surface charge on a surface, methods for increasing adhesion of powder paint to a surface, and surface conditioners for use in such methods.

### CROSS-REFERENCE TO RELATED APPLICATIONS

This application claims priority to U.S. Application No. 60/585,029 filed Jul. 2, 2004, the disclosure of which is incorporated herein by reference in its entirety.

### FIELD OF THE INVENTION

The present invention relates to surface conditioners and methods for powder coating.

### BACKGROUND OF THE INVENTION

Powder coating is a dry finishing process in which an electrically charged powder, generally comprising particles of pigment and resin, is applied on a surface of a substrate, typically by spraying. In some cases, the substrate may have a paint layer or layers, decals, or other decorations from a previous process step. Prior to applying powder coating to a substrate, the substrate surface is generally cleaned to remove dirt and other contaminants. In most cases, the surface of the substrate is cleaned using a cloth soaked in a solvent blend. After solvent wiping the substrate, an additional tack cloth is occasionally used to wipe off fibers that may have been left by the solvent cloth prior to powder coating.

Typical wiping solvent blends include isopropyl alcohol and water or blends of volatile solvent. The typical solvent blends that are used comprise aggressive polar solvents or aromatic solvents that can negatively affect the surface during the wiping step. A particular problem in the industry has been aggressive attack by known solvent blends on the paint and/or decals applied to the surface in previous steps. This attack results in defects which increase scrap rates and requires reworking of the substrate surface.

Another common problem in powder coating substrates is unevenness in the powder coating and other surface defects that show in the surface after cure of the powder coating. In some cases, the surface to be coated has surface flaws, such as scratches, that repel the adhesion of the electrostatic powder coating leaving these scratches visible after curing.

A need exists for a conditioner that improves the ability of the powder coat to coat the surface, minimizes the visibility of defects on the surface to be coated after cure of the powder coating and does not negatively affect the adhesion or appearance of paint or decals already present on the substrate when the conditioner is applied. The present invention addresses these and other needs.

### SUMMARY OF THE INVENTION

In one embodiment, the present invention provides compositions for conditioning a surface before the application of powder coating, methods for conditioning a surface before the application of powder coating and an article of manufacture having at least one surface comprising a layer of the conditioner and an uncured powder coating. The methods comprise contacting the surface with a conductive additive selected to provide more uniform dispersement of the powder coating on a substrate without negatively affect the adhesion or appearance of paint or decals already present on the substrate when the conditioner is applied.

### BRIEF DESCRIPTION OF THE DRAWINGS

FIG. 1 shows a photograph of a powder coated fender treated with a conventional composition.

FIG. 2 shows a photograph of a powder coated fender treated with a conventional composition.

FIG. 3 shows a photograph of a powder coated fender treated with a conventional composition.

FIG. 4 shows a photograph of a powder coated fender treated with a composition according to the present invention.

FIG. 5 shows a photograph of a powder coated fender treated with a composition according to the present invention.

FIG. 6 shows a photograph of a powder coated fender treated with a composition according to the present invention.

FIG. 7 shows a photograph of a powder coated fender treated with a composition according to the present invention.

### DETAILED DESCRIPTION OF ILLUSTRATIVE EMBODIMENTS

The present invention provides, inter alia, surface conditioners comprising one or more conductive additives, wipes containing one or more conductive additives, compositions comprising a surface conditioner and a carrier solvent, articles of manufacture having at least one surface comprising a layer of the conditioner and an uncured powder coating, and methods of conditioning a surface before the application of powder coating. The invention also provides methods of improving the transfer efficiency of powder paint onto a surface, methods of reducing the visibility of defects on powder painted substrates, methods of making a surface charge homogenous on a surface thereby allowing for a more even application of powder coating and/or methods of increasing the adhesion of the powder paint to the substrate prior to and after baking. These methods comprise the step of contacting the surface to be powder coated with a surface conditioner comprising a conductive additive. The methods can further comprise the step of contacting the conditioned surface with powder coating. In some embodiments, the surface conditioner will further comprise a carrier solvent. The conductive additive and carrier solvent can be blended together to form, for example, a solution or dispersion.

Typically, powder paint particles are sprayed from an electrostatic spray gun orifice, pass through the corona (electrons emitted by the electrode of the gun react with molecules in the air generating a cloud of ions), pick up anions, and are attracted to a grounded surface. The difference in the potential between the electrically grounded substrate and powder particle causes the particles to become attracted to the surface. As the surface becomes coated with powder paint, the attraction diminishes due to the electrical insulating effect of the powder paint.

The present inventors have discovered that applying a surface conditioner according to the invention to a surface before coating it with powder coating results in several benefits over the standard products used in the industry. The transfer efficiency of the powder coating is enhanced, the visibility of defects on the powder painted surface is reduced, the charge of the surface is made more homogenous on the surface thereby allowing for a more even application of the powder paint, and/or adhesion of the powder paint to the surface is increased. Without being bound by theory, it is believed that application of a conductive additive film on the surface of a substrate increases the potential difference causing the attraction between the powder paint particle and the electrically grounded substrate to increase.

Any surface that can be powder coated can be conditioned using the methods of the present invention. These surfaces include, for example, metals, including surface treated metals such as metals that have been painted or phosphatized (e.g., a metal panel such as a steel panel that has been coated with a conversion coating, for example iron or zinc phosphate). In one embodiment, the substrate surface is steel, galvanized steel, an aluminum alloy or a magnesium alloy. Other surfaces that can benefit from the application of a surface conditioner of the present invention include, but are not limited, to plastic surfaces, i.e. thermoplastic and thermoset polymeric materials.

The surface conditioners of the present invention comprise a conductive additive. For use herein, a conductive additive is an additive that has a resistivity value by itself of less than about 1.0 Megohms (MΩ), preferably less than about 0.8 Megohms, more preferably less than about 0.5 Megohms, and even more preferably less than about 0.3, 0.2, or 0.1 Megohms. Resistivity of the conductive additive liquid can be conventionally measured, for example, by using a Paint Resistivity Meter (e.g., ITW Ransburg Paint Resistivity Meter Model No. 76652-03) where the probe assembly is placed directly into a beaker containing the liquid to be measured.

Preferably, the conductive additive has a vapor pressure of less than about 2.0 mm Hg at 20° C., more preferably less than about 1.5 mm, or less than about 1.0 mm Hg at 20° C. In some embodiments, the vapor pressure of the conductive additive will be less than about 0.5 mm Hg at 20° C. or less than about 0.3 mm Hg at 20° C. or even less than about 0.2 mm or 0.1 mm Hg at 20° C. Several ASTM methods are known for determining the vapor pressure of liquids, including ASTM D 2879, D 6377, D 323, D 5191. The vapor pressure of the conductive additive should be low enough to avoid substantial evaporation of the additive from the surface of the substrate prior to the powder coating.

The conductive additive will, in preferred embodiments, have a boiling point of greater than about 135° C. at 760 Torr, more preferably greater than about 175° C. at 760 Torr and even more preferably, greater than about 200° C. at 760 Torr. It is understood that if the boiling point is too low, the conductive additive may create problems during the bake cycle of the powder coating or may evaporate off the substrate prior to the powder coating.

In some embodiments, the conductive additive will have a resistivity of less than about 1 Megohms, a vapor pressure of less than about 2.0 mm Hg at 20° C., and a boiling point of greater than about 135° C. at 760 Torr. In one embodiment, the conductive additive will have a resistivity of less than about 0.1 Megohms, a vapor pressure of less than about 0.1 mm Hg at 20° C., and a boiling point of greater than about 200° C. at 760 Torr.

In some embodiments, the conductive additive has the ability to soften or swell paint film on a surface while not negatively affecting any underlying decorative feature, i.e., the additive can diffuse into the polymer to create a swollen gel or increased film or particle size. For example, in some embodiments, the polymer film, e.g., paint film, can be swollen or absorb more than 2% wt. (more preferably >5% wt.) of the additive.

Conductive additives that can be used in the present invention include, but are not limited to benzyl alcohol; N-methylpyrrolidone; furfuryl alcohol; tetrahydrofurfuryl alcohol; phenol; alkoxylated aromatic alcohols; aliphatic alkoxylates, including, aliphatic alcohol alkoxylates; alkanolamines; oxazolidines; alkylamines; and combinations thereof.

The alkoxylated aromatic alcohols of the present invention comprise at least one oxyalkylene moiety per molecule which is attached to an aromatic ring moiety. In some embodiments, the aromatic ring moiety is attached to the oxyalkylene moiety through an ether oxygen alone or through an oxymethylene (—CH₂—O—) moiety.

In one embodiment, the alkoxylated aromatic alcohol has in each molecule an aromatic ring moiety which does not bear any alkyl substituent containing more than 4 carbon atoms, and an oxyalkylene moiety. In preferred embodiments, the alkoxylated aromatic alcohol has from about 1 mole to about 10 moles of alkoxylation per mole of the ring moiety. In some embodiments, the alkoxylation will comprise ethoxylation or propoxylation or combinations of both in each molecule.

In one embodiment, the oxyalkylene moiety (also referred to herein as the alkoxylate unit) is represented by the following formula: 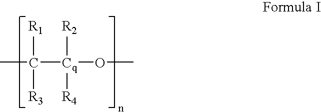
wherein:
R₁, R₂, R₃ and R₄ are independently hydrogen, halogen, or methyl;
n is from 1 to 10, and
q is independently 1 or 2 for each of the n moieties.

In some embodiments of the present invention, the alkoxylated aromatic alcohol has the following formula: 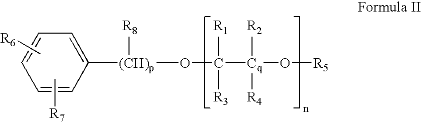
wherein:
R₁, R₂, R₃ and R₄ are independently, halogen, hydrogen or methyl;
R₅ is hydrogen, C₁₋₆ alkyl, or phenyl;
R₆, R₇ and R₈ are independently hydrogen, halogen, or C₁₋₄ alkyl;
q is independently 1 or 2 for each of the n moieties;
p is 0 or 1; and
n is from 1 to 10.

The present invention can comprise one or more alkoxylated compounds of Formula II wherein “n” represents an average number of alkoxylate units. In some embodiments, n is from 3 to 5.

In some embodiments,
R₁, R₂, R₃ and R₄ are independently hydrogen;
R₅ is hydrogen or methyl;
R₆, R₇ and R₈ are independently hydrogen;
q is independently 1 or 2 for each of the n moieties;
n is from 1 to 10, and
p is 0 or 1.

Representative alkoxylated aromatic alcohols include, but are not limited to, ethylene glycol monophenyl ether, diethylene glycol monophenyl ether, triethylene glycol monophenyl ether, tetraethylene glycol monophenyl ether, pentaethylene glycol monophenyl ether, hexaethylene glycol monophenyl ether, heptaethylene glycol monophenyl ether, ethylene glycol monobenzyl ether, diethylene glycol monobenzyl ether, triethylene glycol monobenzyl ether, tetraethylene glycol monobenzyl ether, pentaethylene glycol monobenzyl ether, hexaethylene glycol monobenzyl ether, heptaethylene glycol monobenzyl ether, water-soluble ethoxylates of propylene glycol monophenyl ether and the like, alkoxylated furfuryl alcohol, and mixtures thereof. Suitable alkoxylated aromatic alcohols are available from commercial sources such as Harcross (T DET P4) and Clariant (ST-8329 and GENAPOL® BA 010, 020, 030, 040, and 060), and include CAS No. 26403-74-7 (Polyoxyethylene benzyl alcohol ether), and CAS No. 9004-78-8 (Poly(oxy-1,2-ethanediyl).

In one embodiment, the alkoxylated aromatic alcohol is benzyl alcohol ethoxylated with four moles of ethylene oxide per one mole of benzyl alcohol.

The ring moieties of the alkoxylated aromatic alcohols can be any substituted or unsubstituted aromatic hydrocarbon ring group having 5 to about 50 carbon atoms (unless explicitly specified otherwise) with from about 6 to about 14 atoms being preferred. The ring moiety can be a single ring or multiple condensed rings. Preferred ring moieties include but are not limited to phenyl and naphthyl. The ring moieties can also be substituted or unsubstituted aromatic heterocyclic ring system (monocyclic or bicyclic). Heteroaryl groups can have, for example, from about 3 to about 50 carbon atoms (unless explicitly specified otherwise), with from about 4 about 10 being preferred. Preferred heteroaryl groups include, but are not limited to, 5 to 7-membered mono- or 9- to 10-membered bicyclic heteroaryl rings, which can be saturated or unsaturated, wherein the heteroaryl ring optionally contains from one to four nitrogen heteroatoms. Particularly preferred heteroaryl rings include pyridyl or indolyl rings such as, for example, 2-pyridyl or indo-1-yl.

Any of the positions on the aromatic rings of the alkoxylated aromatic alcohols can be unsubstituted or substituted and at least one of the positions on these rings is substituted with an oxyalkylene moiety. An oxyalkylene moiety can be produced, for example, by condensing at least one alkylene oxide (e.g., ethylene oxide, propylene oxide) with a suitable compound having at least one active hydrogen (e.g., phenol, benzyl alcohol), as is generally well known in the art. Alkoxylation is preferably carried out under conditions effective to react an average of at least one mole of alkylene oxide per mole of active hydrogen in the aromatic alcohol.

The aliphatic alkoxylates of the present invention generally comprise at least one oxyalkylene moiety per molecule which can be attached to an optionally substituted branched or linear alkyl moiety.

Branched or linear aliphatic alkoxylates and alkanolamines for use herein include, but are not limited to, non-ionic surfactants, such as TERGITOL TMN-6 and TERGITOL TMN-3, ethylene glycol ether, propylene glycol ether solvents, propylene glycol propyl ether, propylene glycol butyl ether, diethylene glycol butyl ether, dibasic esters or combinations thereof and primary, secondary or tertiary alkanolamines such as 2-aminopropanol-1 (also known as monoisopropanolamine). Other suitable alkanolamines include, but are not limited to, dimethylethanolamine, monoethanolamine, diethanolamine, triethanolamine, triisopropanolamine, monoethanolamine, n-butyl diethanolamine, 2-methylaminoethanol, n-butylaminoethanol, diethylaminoethanol, 2-amino-2-methyl-1-propanol, phenyl diethanolamine, diisopropanolamine and the like.

In some embodiments of the present invention, there will be an alcohol functional group present on the conductive additive. In such embodiments, the conductive additive can, for example, react with a polymer coating by chemically forming a covalent bond between the conductive additive and the polymer coating. For example, in embodiments wherein the powder resin incorporates an isocyanate curing mechanism, the alcohol functionality can be reacted with the isocyanate resin to form a urethane linkage.

Any method of applying the conductive additive to the surface to be power coated can be used in the present invention. For example, the conductive additive can be used in the form of a pre-wipe comprising the conductive additive or may be applied to a clean cloth or aerosolized, and subsequently applied to an appropriate surface for conditioning. In some embodiments, the conductive additive will be applied in combination with a carrier solvent. The carrier solvent to be used in the present invention can be any solvent capable of dissolving or dispersing the conductive additive. In a preferred embodiment, the carrier solvent will dissolve the conductive additive thereby forming a clear homogeneous solution. It is desirable that the carrier solvent evaporates from the substrate prior to electrostatically applying the powder paint. In preferred embodiments, the carrier solvent will have a vapor pressure greater than about 2 mm Hg at 20° C., more preferably greater than about 5 mm Hg at 20° C., even more preferably greater than about 8 mm Hg at 20° C., or 10 mm Hg at 20° C. Using routine methods known in the art, a skilled practitioner will be able to determine what solvent can dissolve or disperse the conductive additive and evaporate from the substrate before application of the powder coating. In one embodiment, a composition comprising a carrier solvent and conductive additive conditions the surface of a substrate thereby allowing for an even coating of the conductive additive to be applied the substrate. Prior to powder coating, the carrier solvent evaporates from the substrate leaving the conductive additive on the surface of the substrate.

Carrier solvents for applying the conductive additive to a painted substrate to be powder coated include solvents that do not dissolve the paint on the substrate or otherwise create a defect in the painted substrate. In one preferred embodiment, the carrier solvent has either no volatile organic content, such as water, or a volatile organic content of, in increasing order of preference, less than 10, 5, 2, 1, 0.5, 0.25, 0.15, 0.10, 0.05, 0.01, 0.005, 0.001, 0.0005, 0.0001 parts per thousand. Preferred carrier solvents include water; aliphatic hydrocarbons, preferably branched or straight C₁₋₈ aliphatic hydrocarbons (e.g., methane, ethane, propane, butane, pentane, hexane, heptane, octane, nonane, or decane); alcohols such as aliphatic alcohols, preferably branched or straight C₁₋₆ aliphatic alcohols (e.g., methanol, ethanol, propanol, butanol, pentanol, or hexanol); or combinations thereof. Exemplary solvents include, for example, hexane, heptane, VM&P Naphtha (hydrocarbon blend), Light Aliphatic Hydrocarbons, and some mineral spirits grades depending on their vapor pressure as described herein. In a preferred embodiment, the alcohol will couple the conductive additive into the solution of aliphatic hydrocarbons. Coupling solvents like alcohols, or in particular, isopropyl alcohol, can be used separately or blended with aliphatic hydrocarbons to create a blend of solvents capable of dissolving or dispersing otherwise non-soluble conductive additives into solution. Exemplary solvents blends include, for example, aliphatic alcohols and aliphatic hydrocarbons.

Aggressive solvents like acetone; acetates (e.g., n-butyl acetate); ketones (e.g., methyl ethyl ketone); and select aromatics (e.g., xylene) are not desirable for use in formulations for conditioning painted substrates but can be used in formulations for conditioning bare metal.

In some embodiments, the surface conditioners or compositions of the present invention comprise from about 95% to about 99.999% by weight of one or more carrier solvents and from about 0.001% to about 5% by weight, more preferably from 0.001% to about 1% by weight, and even more preferably from 0.001% to about 0.5% by weight of one or more conductive additives. In other embodiments, a surface conditioner of the present invention can comprise about 100% conductive additive.

In one embodiment, the surface conditioner will comprise from about 50% by weight to about 97% by weight of one or more aliphatic hydrocarbons, from about 1% by weight to about 40% by weight of one or more aliphatic alcohols and from about 0.001% by weight to about 5% by weight of one or more conductive additives. For example, in one aspect, the formulation will comprise from about 90% by weight to about 95% by weight one or more aliphatic hydrocarbons, from about 5% by weight to about 7% by weight one or more aliphatic alcohols, and from about 0.5% by weight to about 2.5% by weight one or more conductive additives.

In one embodiment, the surface conditioner will comprise alkoxylated benzyl alcohol, isopropyl alcohol, hydrocarbon blend (e.g., VM&P Naphtha) and heptane.

The present invention is, in part, directed to methods of using the surface conditioner to condition a surface before applying powder coating. In methods of the present invention, contact between the surface conditioner as described herein and any surface to be powder coated can be brought about by any convenient method. For example, the surface to be powder coated can be wiped with a surface conditioner of the present invention, dipped in a surface conditioner of the present invention, or sprayed with a surface conditioner of the present invention. Immersion and spraying are the most common methods. If the surface to be powder coated has a shape that can be readily and reasonably uniformly contacted by spraying, this method of contact is generally preferred, because the mechanical force of impingement of the sprayed solution aids in application. If the surface conditioner is sprayed onto a surface, the spraying pressure will usually range from about 20 pounds per square inch (“psi”) to about 160 psi. It is understood that spray pressure or immersion time or temperature can be readily adjusted to prevent negative effects on decorative features such as paint or decals previously applied to the substrate.

If the surface to be cleaned has recesses or other shapes that can not readily be contacted by spraying, wiping will generally be preferred. Both methods can, of course be combined and/or varied in ways apparent to those skilled in the art. The optimum values of active ingredient concentrations and temperature of the working solution depend to some extent on the method of contact and the impingement force (if any) achieved by the contact. General guidelines for spraying are given below, but in any instance, those skilled in the art will be able to determine optimum conditions by minimal experimentation.

In one embodiment, the surface conditioners are useful for conditioning the surface of an automobile substrate (including motorcycle substrate) before coating the substrate with powder. Prior to the application of the powder coating, the substrate surface is wiped with a surface conditioner of the present invention. The substrate may be further wiped using a tacky cloth to pick up any residual fibers from the substrate surface. Powder coating is then applied. After applying the powder paint to the substrate, the substrate is carried into an oven to cure the powder coating.

Surface conditioners of the present invention can be applied to a wipe or pre-wipe for application to the surface to be conditioned. The term wipe or pre-wipe refers to any material, cloth or otherwise, that can be used to apply the conditioner to a surface. Accordingly, the present invention provides wipes or pre-wipes comprising surface conditioners of the present invention.

The invention and its benefits will be better understood with reference to the following examples. These examples are intended to illustrate specific embodiments within the overall scope of the invention as claimed, and are not to be understood as limiting the invention in any way.

### EXAMPLES

### Example 1

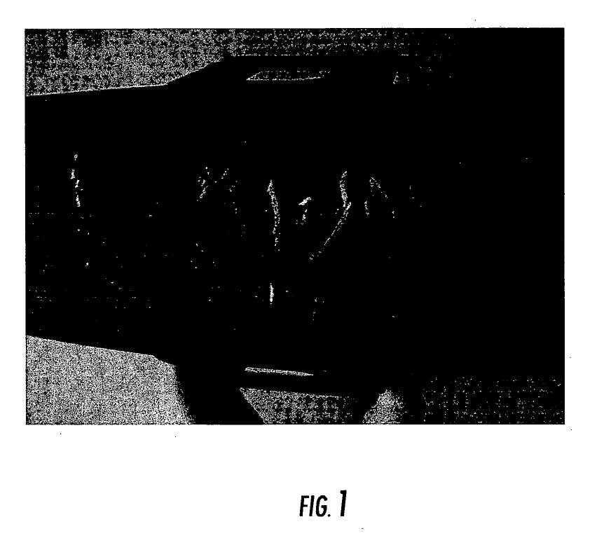

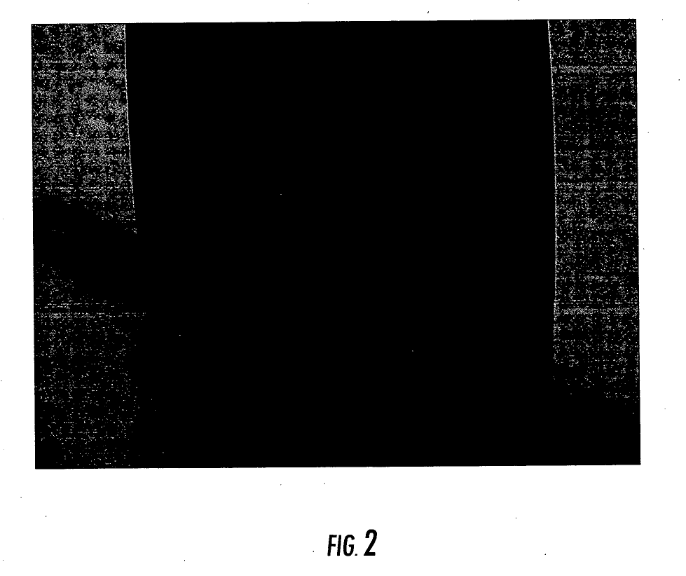

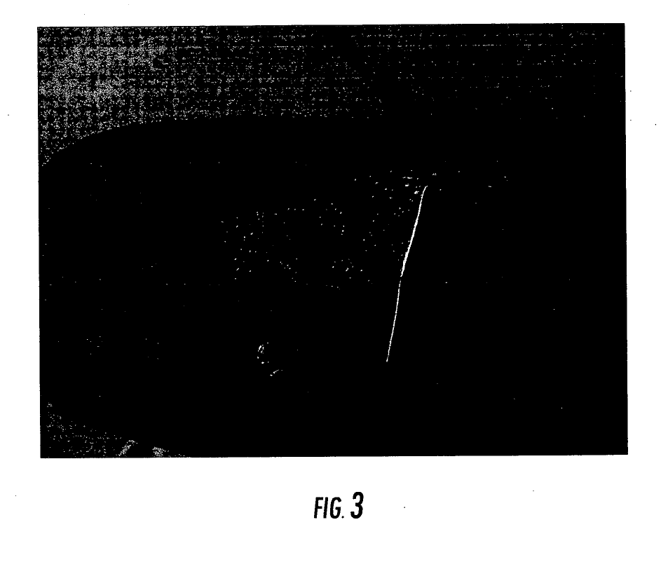

A motorcycle fender was painted with primer and basecoat. A long scratch down to bare metal was put onto the fender and the fender was wiped with a commercial solvent blend on a POLYNIT wipe. The solvent blend contained greater than 60% wt. naphtha, petroleum, and light aliphatic naphtha, about 10-30% wt. isopropyl alcohol, and about 10-30% wt. n-Heptane. The fender was lightly sprayed with a powder paint “PBS6-9018, AUM Modified Black Low Cure” from Sherwin Williams. With the light coating it was possible to see areas of the fender that repelled the electrostatically applied black powder coating. Several areas of the fender would not allow powder to coat the surface of the painted fender as shown in FIGS. 1-3.

### Example 2

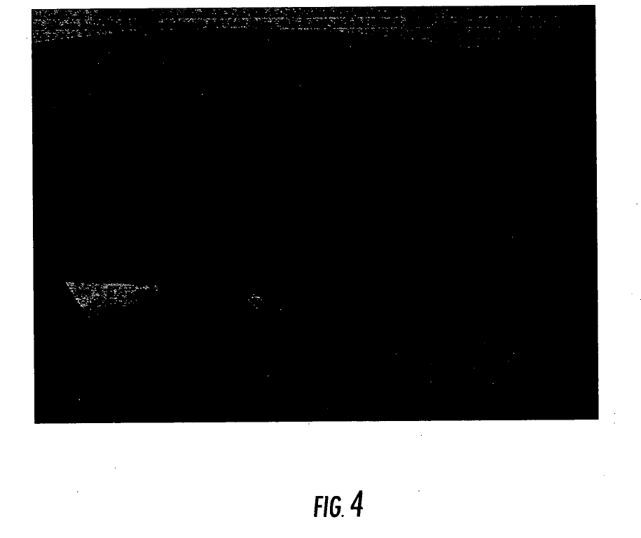

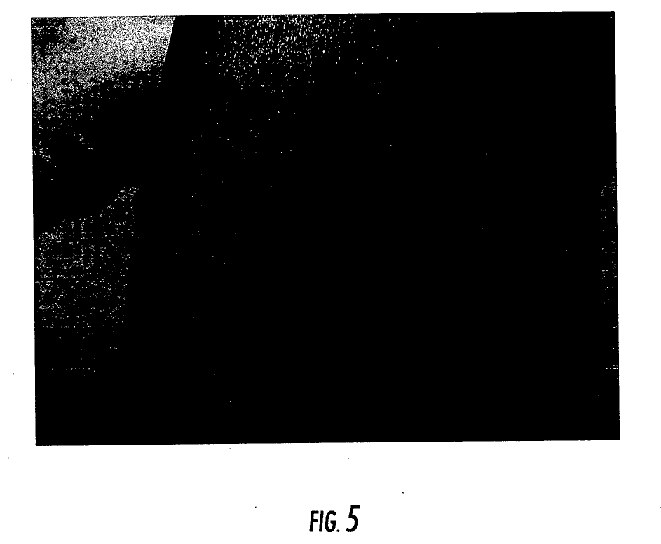

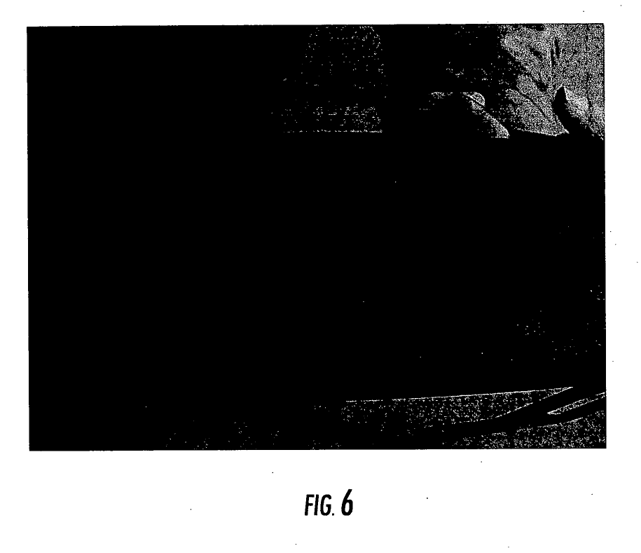

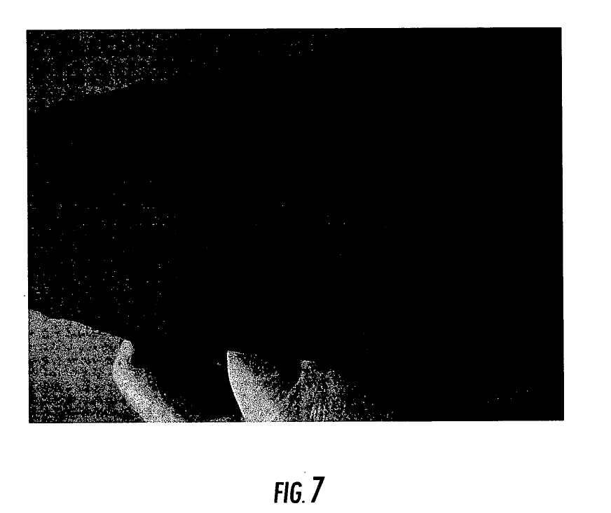

After blowing off the powder paint from the fender from Example 1, a blend comprising about 45% by weight n-heptane, about 49.5% by weight a hydrocarbon blend (e.g., VM&P naphtha), about 5% by weight isopropyl alcohol, and about 0.5% by weight alkoxylated benzyl alcohol ethoxylated with an average of 4 moles of ethylene oxide per 1 mole of benzyl alcohol was applied to the fender. The fender was sprayed lightly with power coating. After one light coating of powder paint, the fender was evenly covered with the powder coating including the scratched area. There was no area on the surface that resisted powder coating as shown in FIGS. 4-7.

### Example 3

A blend comprising about 45% by weight heptane, about 49% by weight a hydrocarbon blend (e.g., VM&P naphtha), about 5% by weight isopropyl alcohol, and about 1% by weight alkoxylated benzyl alcohol ethoxylated with an average of 4 moles of ethylene oxide per 1 mole of benzyl alcohol and a blend comprising about 43% by weight heptane, about 47.5% by weight a hydrocarbon blend (e.g., VM&P naphtha), about 7% by weight isopropyl alcohol, and about 2.5% by weight alkoxylated benzyl alcohol ethoxylated with an average of 4 moles of ethylene oxide per 1 mole of benzyl alcohol were applied to phophatized panels that were subsequently coated with powder coating. The powder paint adhered to the panels.

The invention has been described with reference to various specific and preferred embodiments and techniques. Alternatives and variations of the examples are within the scope of the present invention and can be carried out by a person skilled in the art. Ingredients may be exchanged for equivalent ingredients. It should be understood that many variations and modifications might be made while remaining within the spirit and scope of the invention.

1. A method for conditioning a surface before application of powder coating comprising contacting the surface with a surface conditioner comprising a conductive additive.

2. The method of claim 1 further comprising the step of applying powder coating to the surface after contacting the surface with the surface conditioner.

3. The method of claim 1 wherein the conductive additive has a resistivity value of less than about 1.0 Megohms and a vapor pressure of less than about 2.0 mm Hg at 20° C.

4. The method of claim 3 wherein the conductive additive has a vapor pressure of less than about 0.3 mm Hg at 20° C.

5. The method of claim 3 wherein the conductive additive has a boiling point of greater than about 135° C. at 760 Torr.

6. The method of claim 1 wherein the conductive additive is benzyl alcohol, N-methyl pyrrolidone, an alkoxylated aromatic alcohol, furfuryl alcohol, tetrahydrofurfuryl alcohol, an aliphatic alkoxylate, an alkanolamine, an oxazolidine, an alkylamine, or a combination thereof.

7. The method of claim 1 wherein the conductive additive is an alkoxylated aromatic alcohol.

8. The method of claim 1 wherein the conductive additive is represented by Formula II: 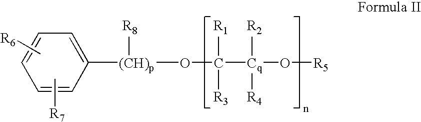
wherein:
R₁, R₂, R₃ and R₄ are independently, halogen, hydrogen or methyl;
R₅ is hydrogen, C₁₋₆ alkyl, or phenyl;
R₆, R₇ and R₈ are independently hydrogen, halogen, or C₁₋₄ alkyl;
q is independently 1 or 2 for each of the n moieties;
p is 0 or 1; and
n is from 1 to 10.

9. The method of claim 8 wherein is from 3 to about 5.

10. The method of claim 1 wherein the conductive additive is alkoxylated benzyl alcohol.

11. The method of claim 10 wherein the alkoxylated benzyl alcohol is ethoxylated or propoxylated.

12. The method of claim 11 wherein the alkoxylated benzyl alcohol is ethoxylated with an average of 4 moles of ethylene oxide per 1 mole of benzyl alcohol.

13. The method of claim 1 wherein the surface conditioner further comprises a carrier solvent

14. The method of claim 13 wherein the carrier solvent has a vapor pressure of greater than about 2.0 mm Hg at 20° C.

15. The method of claim 13 wherein the carrier solvent is an aliphatic hydrocarbon, an aliphatic alcohol, water, or a combination thereof.

16. The method of claim 15 wherein the aliphatic alcohol is isopropyl alcohol.

17. The method of claim 13 wherein the surface conditioner comprises about 95% to 99.999% by weight of one or more carrier solvents and about 0.001% to about 5% by weight of one or more conductive additives.

18. The method of claim 13 wherein the surface conditioner comprise from about 50% to about 97% by weight of one or more aliphatic hydrocarbons, from about 1% to about 40% by weight of one or more aliphatic alcohols, and from about 0.001% to about 5% by weight of one or more conductive additives.

19. A pre-wipe containing a surface conditioner comprising a conductive additive selected from the group consisting of benzyl alcohol, N-methylpyrrolidone, an alkoxylated aromatic alcohol, an aliphatic alkoxylate, an alkanolamine, an oxazolidine, an alkylamine, and combinations thereof and a carrier solvent selected from the group consisting of water, an aliphatic hydrocarbon, an aliphatic alcohol, and combinations thereof.

20. The pre-wipe of claim 19, wherein the conductive additive is benzyl alcohol, an alkoxylated aromatic alcohol, an alkanolamine, or combinations thereof.

21. The pre-wipe of claim 19, wherein the surface conditioner includes n-heptane, VM&P naphtha, isopropyl alcohol, and alkoxylated benzyl alcohol ethoxylated with an average of 4 moles of ethylene oxide per 1 mole of benzyl alcohol.

22. The pre-wipe of claim 19, wherein the surface conditioner includes about 45% weight n-heptane, about 49.5% weight VM&P naphtha, about 5% weight isopropyl alcohol, and about 0.5% weight alkoxylated benzyl alcohol ethoxylated with an average of 4 moles of ethylene oxide per 1 mole of benzyl alcohol.

23. A composition for improving powder coating transfer to a surface comprising a conductive additive selected from the group consisting of benzyl alcohol, an alkoxylated aromatic alcohol, an alkanolamine, and combinations thereof and a carrier solvent selected from the group consisting of water, an aliphatic hydrocarbon, an aliphatic alcohol, and combinations thereof.

24. The composition of claim 23 wherein the composition comprises from about 50% to about 97% by weight of one or more aliphatic hydrocarbons, from about 1% to about 40% by weight of one or more aliphatic alcohol, and from about 0.001% to about 5% by weight of one or more alkoxylated aromatic alcohol.

25. An article of manufacture made according to the method of claim 2 wherein the surface comprises a layer comprising the conductive additive and uncured powder coating.

26. The article of manufacture of claim 25 further comprising a paint film between the surface and said layer comprising more than 2% wt. of the conductive additive.
